(19) United States
(12) Patent Application Publication
(10) Pub. No.: US 2013/0074620 A1
(43) Pub. Date: Mar. 28, 2013

(54) SEMIAUTOMATIC ROTATIONAL/SWINGING DEVICE

(71) Applicants: AN SZU HSU, NEW TAIPEI CITY (TW); CHIEN NAN TSAI, NEW TAIPEI CITY (TW)

(72) Inventors: AN SZU HSU, NEW TAIPEI CITY (TW); CHIEN NAN TSAI, NEW TAIPEI CITY (TW)

(73) Assignee: FIRST DOME CORPORATION, NEW TAIPEI CITY (TW)

(21) Appl. No.: 13/241,888

(22) Filed: Sep. 23, 2011

(51) Int. Cl. F16H 35/18

(52) U.S. Cl. 74/10.7

(57) ABSTRACT

A semiautomatic rotational/swinging device includes a relative pivoting member, a pivoting member pivotally connected with the relative pivoting member via a pivot pin, and multiple strip-like torsion elastic members each having two end sections connected with the relative pivoting member and the pivoting member respectively. The torsion elastic members are obliquely disposed between the relative pivoting member and the pivoting member around the pivot pin. When the pivoting member and the relative pivoting member are pivotally rotated relative to each other, the end sections of the torsion elastic members are gradually shifted from the original misaligned position to an aligned position. At this time, the torsion elastic members are compressed to store energy. After the end sections pass over the aligned position, the torsion elastic members stretch from the compressed state to push the pivoting member and the relative pivoting member to automatically pivotally rotate relative to each other.

### BACKGROUND OF THE INVENTION

1. Field of the Invention

The present invention relates generally to a semiautomatic rotational/swinging device, which has simple structure and is easy to assemble. Moreover, the semiautomatic rotational/swinging device is easily adjustable in torsional elasticity to provide high torque.

2. Description of the Related Art

Various electronic products with snap-on covers or snap-on screens have been developed in the market. Various pivot devices are widely applied to these snap-on covers. FIGS. 1 and 2 show a conventional pivot device including a pivot seat 4, a pivot pin 40, a first cam 5, a second cam 5a identical to the first cam 5, two identical retainer plates 6, 6a and an elastic member 60. The pivot seat 4 has a sideboard 41 perpendicularly extending from the pivot seat 4. The sideboard 41 is formed with a central pinhole 42. A raised stop section 45 is disposed beside the pinhole 42. A flange section 401 is disposed at the middle of the pivot pin 40. A restriction shaft section 402 is formed at one end of the pivot pin 40. The restriction shaft section 402 has a plane face 403. The restriction shaft section 402 extends through the pinhole 42 of the sideboard 41 with the flange section 401 abutting against the sideboard 41. A stop block 46 is disposed between the flange section 401 and the sideboard 41. The stop block 46 is synchronously rotatable with the pivot pin 40. Two opposite stop sections 461, 462 are formed on a circumference of the stop block 46. The stop section 45 of the sideboard 41 can stop the stop sections 461, 462 to restrict the rotational angle. The first and second cams 5, 5a is rotatably fitted on the restriction shaft section 402. The first cam 5 has two fixing keys 51 fixedly inserted in two corresponding fixing sections 43, 44 of the sideboard 41, (such as two fixing holes 44 or two fixing notches 43 or a fixing notch 43 and a fixing hole 44). The second cam 5a has two fixing keys 51a fixedly inserted in two corresponding fixing sections of the retainer plate 6, (such as two fixing notches 51). The opposite sides of the first and second cams 5, 5a respectively have frictional faces. The frictional faces are respectively formed with raised sections 54, 54a and recessed sections 53, 53a. The retainer plates 6, 6a are synchronously drivingly fitted on the restriction shaft section 402. The elastic member 60 is positioned between the retainer plates 6, 6a. The elastic member 60 is composed of multiple arcuate leaf springs 601, which are synchronously drivingly fitted on the restriction shaft section 402. In addition, a fastening member 404 is affixed to the end of the restriction shaft section 402 for fastening the retainer plate 6a.

In practice, when the first and second cams 5, 5a are positioned in a home position, the raised section 54 of the first cam 5 is inlaid in the recessed section 53a of the second cam 5a, while the raised section 54a of the second cam 5a is correspondingly inlaid in the recessed section 53 of the first cam 5 to provide a locating effect.

When the pivot pin 40 is rotated relative to the pivot seat 4, the restriction shaft section 402 drives the retainer plate 6 to rotate. At this time, the second cam 5a is synchronously rotated with the pivot pin 40. Under such circumstance, the raised section 54 of the first cam 5 is moved out of the recessed section 53a of the second cam 5a into contact with the frictional face of the second cam 5a, while the raised section 54a of the second cam 5a is moved out of the recessed section 53 of the first cam 5 into contact with the frictional face of the first cam 5 to change the torsion. When the pivot pin 40 is restored to its home position, the raised sections 54, 54a gradually approach the recessed sections 53a, 53 to be automatically inlaid back into the recessed sections 53a, 53 again.

In such structure, the pivot pin 40 can be freely located at a specific angle under sufficient frictional force. However, the arcuate leaf springs 601 can only provide limited elasticity so that it is hard to provide greater frictional force for the pivot pin 40. Therefore, such structure can be hardly applied to a large-size electronic product for locating the snap-on cover. Moreover, such structure is relatively complicated and is difficult to assemble. Also, it is uneasy to replace the elastic member 60. Furthermore, the frictional force applied to the pivot pin 40 is fixed and unadjustable.

### SUMMARY OF THE INVENTION

It is therefore a primary object of the present invention to provide a semiautomatic rotational/swinging device. At the later stage of the pivotal rotation of a pivoting member and a relative pivoting member, a greater drive torque is applied to the pivoting member and the relative pivoting member. In this case, the pivoting member and the relative pivoting member can automatically pivotally rotate relative to each other to a predetermined fixed position without external force.

It is a further object of the present invention to provide the above semiautomatic rotational/swinging device in which the number of the torsion elastic members can be easily increased or decreased to change the torque applied to the pivoting member and the relative pivoting member in accordance with different requirements. Therefore, the semiautomatic rotational/swinging device is widely applicable in various fields.

It is still a further object of the present invention to provide the above semiautomatic rotational/swinging device, which has very simple structure and is easy to assemble. Therefore, the manufacturing cost is lowered to promote the competitive power of the product.

To achieve the above and other objects, the semiautomatic rotational/swinging device of the present invention includes: a relative pivoting member; a pivoting member pivotally rotatable around a preset axis relative to the relative pivoting member; and at least one torsion elastic member, the torsion elastic member being a strip-like elastic body, each torsion elastic member having two end sections connected with the relative pivoting member and the pivoting member respectively, whereby the torsion elastic member is obliquely disposed between the relative pivoting member and the pivoting member beside the axis.

In the above semiautomatic rotational/swinging device, the relative pivoting member is formed with a receiving space having an opening. The pivoting member is capped on the opening.

In the above semiautomatic rotational/swinging device, a pinhole is formed on a bottom wall of the receiving space of the relative pivoting member. The pivoting member has a pivot pin corresponding to the pinhole. The pivot pin is inserted in the pinhole, whereby the pivoting member and the relative pivoting member can be pivotally rotated around an axis of the pivot pin relative to each other.

In the above semiautomatic rotational/swinging device, multiple inward protruding stop sections are disposed on an end face of the opening of the receiving space. The pivoting member has multiple connection sections arranged on a circumference of the pivoting member. The connection sections of the pivoting member are positioned between the stop sections.

In the above semiautomatic rotational/swinging device, each connection section has a raised restriction section disposed on one side of the connection section, which side is proximal to the receiving space. The restriction sections abut against inner circumference of the opening of the receiving space.

In the above semiautomatic rotational/swinging device, the end sections of the torsion elastic member are formed with located sections. The located sections have a polygonal cross section. The pivoting member and the relative pivoting member are formed with locating sections. The locating sections have a configuration identical to that of the located sections. The located sections are respectively connected with the locating sections.

In the above semiautomatic rotational/swinging device, the locating sections are holes in which the located sections are inserted.

The present invention can be best understood through the following description and accompanying drawings, wherein:

### BRIEF DESCRIPTION OF THE DRAWINGS

FIG. 1 is a perspective exploded view of a conventional rotary shaft structure with torsional elasticity;

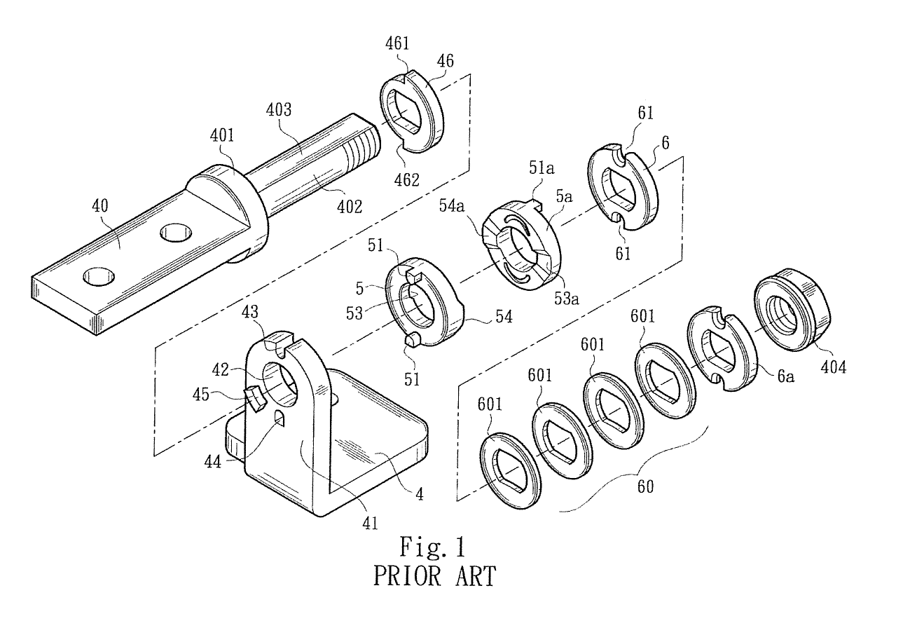

FIG. 2 is a perspective assembled view of the conventional rotary shaft structure according to FIG. 1;

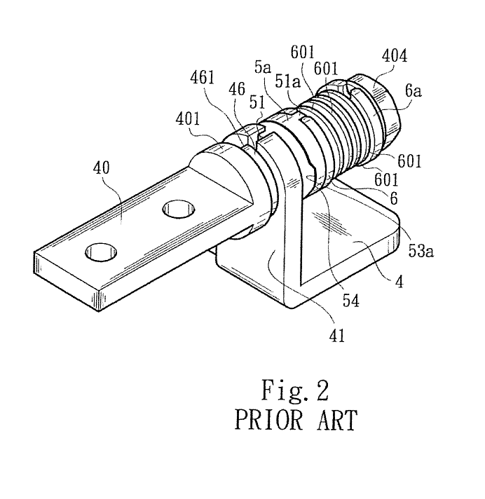

FIG. 3 is a perspective exploded view of the present invention;

FIG. 4 is a perspective assembled view of the present invention;

FIG. 5 is a perspective view showing the torsion operation of the present invention in one state; and

FIG. 6 is a perspective view showing the torsion operation of the present invention in another state.

### DETAILED DESCRIPTION OF THE PREFERRED EMBODIMENTS

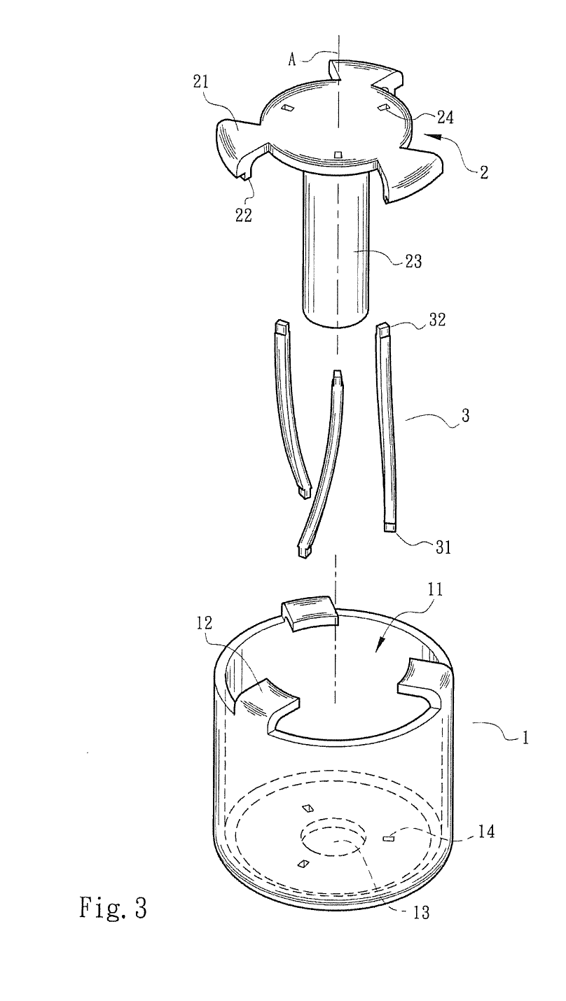

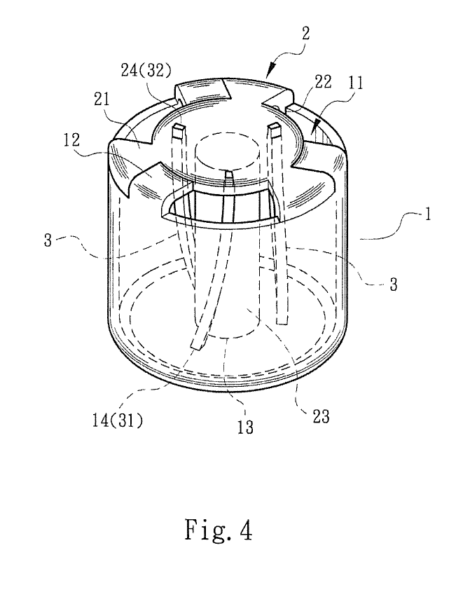

Please refer to FIGS. 3 and 4. The semiautomatic rotational/swinging device of the present invention mainly includes a relative pivoting member 1, a pivoting member 2 and multiple torsion elastic members 3. The relative pivoting member 1 is formed with a receiving space 11 having an opening. A pinhole 13 is formed on a bottom wall of the receiving space 11. Multiple locating sections 14, (which can be holes), are formed on the bottom wall around the pinhole 13. In addition, multiple inward protruding stop sections 12 are disposed on an end face of the opening of the receiving space 11. The pivoting member 2 has multiple outward protruding connection sections 21 arranged on a circumference of the pivoting member 2. Each connection section 21 has a raised restriction section 22 disposed on one side of the connection section 21, which side is proximal to the receiving space 11. The restriction sections 22 abut against inner circumference of the opening of the receiving space 11. The pivoting member 2 is formed with multiple locating sections 24, which can be holes. The pivoting member 2 is capped on the opening of the receiving space 11. A pivot pin 23 is disposed on one side of the pivoting member 2, which side faces the receiving space 11. The pivot pin 23 can be inserted into the pinhole 13, whereby the pivoting member 1 and the relative pivoting member 1 can be pivotally rotated around the axis A of the pivot pin 23 relative to each other. The connection sections 21 of the pivoting member 2 are positioned between the stop sections 12. The restriction sections 22 abut against inner circumference of the opening of the receiving space 11, whereby the pivoting member 2 can be pivotally rotated on the opening of the receiving space 11 without detachment. The stop sections 12 serve to stop the connection sections 21 to restrict the rotational angle of the pivoting member 2. The torsion elastic members 3 are strip-like elastic bodies. Each torsion elastic member 3 has two end sections formed with located sections 31, 32. The cross section of the located sections 31, 32 has a configuration identical to that of the locating sections 14, 24, (which can be polygonal or quadrangular shape). The located sections 31, 32 are respectively inserted in the locating sections 14, 24, whereby the torsion elastic members 3 are obliquely located between the pivoting member 2 and the relative pivoting member 1 around the pivot pin 23 without possibility of self-rotation.

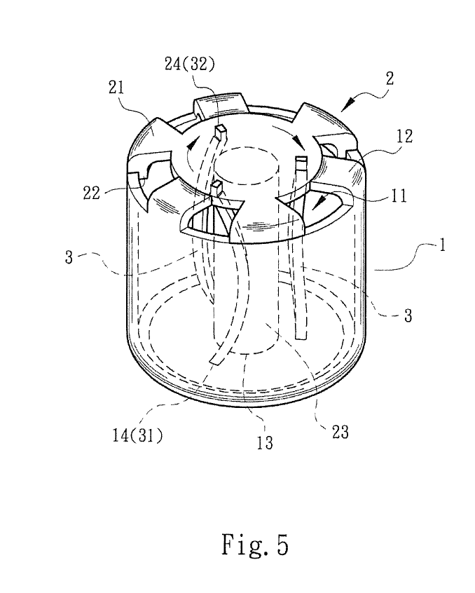

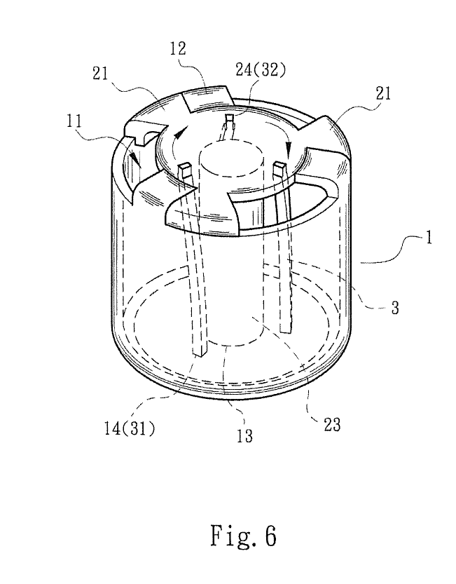

Please now refer to FIGS. 5 and 6. In operation, when the pivoting member 2 and the relative pivoting member 1 are forcedly pivotally rotated relative to each other, the end sections of the torsion elastic members 3 are gradually shifted from the original misaligned position to an aligned position. At this time, the distance between the locating sections 24 of the pivoting member 2 and the locating sections 14 of the relative pivoting member 1 is shortest. Under such circumstance, the torsion elastic members 3 are compressed to a maximum extent (as shown in FIG. 5) to store energy. After the end sections of the torsion elastic members 3 pass over the aligned position, the torsion elastic members 3 stretch from the compressed state to release energy for pushing the pivoting member 2 and the relative pivoting member 1 to automatically pivotally rotate relative to each other. Accordingly, at the later stage of the pivotal rotation, a greater drive torque is applied to the pivoting member 2 and the relative pivoting member 1. In this case, the pivoting member 2 and the relative pivoting member 1 can automatically pivotally rotate relative to each other to a predetermined fixed position without external force (as shown in FIG. 6).

In practice, the number of the torsion elastic members 3 can be easily increased or decreased to change the torque applied to the pivoting member 2 and the relative pivoting member 1 in accordance with different requirements. Therefore, the semiautomatic rotational/swinging device of the present invention is widely applicable in various fields. Moreover, the semiautomatic rotational/swinging device of the present invention has very simple structure and is easy to assemble. Therefore, the manufacturing cost is lowered to promote the competitive power of the product.

In conclusion, the semiautomatic rotational/swinging device of the present invention has greater torque and is easily adjustable in torsional elasticity.

The above embodiments are only used to illustrate the present invention, not intended to limit the scope thereof. Many modifications of the above embodiments can be made without departing from the spirit of the present invention.

What is claimed is:

1. A semiautomatic rotational/swinging device comprising:
a relative pivoting member;
a pivoting member pivotally rotatable around a preset axis relative to the relative pivoting member; and
at least one torsion elastic member, the torsion elastic member being a strip-like elastic body, each torsion elastic member having two end sections connected with the relative pivoting member and the pivoting member respectively, whereby the torsion elastic member is obliquely disposed between the relative pivoting member and the pivoting member beside the axis.

2. The semiautomatic rotational/swinging device as claimed in claim 1, wherein the relative pivoting member is formed with a receiving space having an opening, the pivoting member being capped on the opening.

3. The semiautomatic rotational/swinging device as claimed in claim 2, wherein a pinhole is formed on a bottom wall of the receiving space of the relative pivoting member, the pivoting member having a pivot pin corresponding to the pinhole, the pivot pin being inserted in the pinhole, whereby the pivoting member and the relative pivoting member can be pivotally rotated around an axis of the pivot pin relative to each other.

4. The semiautomatic rotational/swinging device as claimed in claim 2, wherein multiple inward protruding stop sections are disposed on an end face of the opening of the receiving space, the pivoting member having multiple connection sections arranged on a circumference of the pivoting member, the connection sections of the pivoting member being positioned between the stop sections.

5. The semiautomatic rotational/swinging device as claimed in claim 3, wherein multiple inward protruding stop sections are disposed on an end face of the opening of the receiving space, the pivoting member having multiple connection sections arranged on a circumference of the pivoting member, the connection sections of the pivoting member being positioned between the stop sections.

6. The semiautomatic rotational/swinging device as claimed in claim 4, wherein each connection section has a raised restriction section disposed on one side of the connection section, which side is proximal to the receiving space, the restriction sections abutting against inner circumference of the opening of the receiving space.

7. The semiautomatic rotational/swinging device as claimed in claim 5, wherein each connection section has a raised restriction section disposed on one side of the connection section, which side is proximal to the receiving space, the restriction sections abutting against inner circumference of the opening of the receiving space.

8. The semiautomatic rotational/swinging device as claimed in claim 1, wherein the end sections of the torsion elastic member are formed with located sections, the located sections having a polygonal cross section, the pivoting member and the relative pivoting member being formed with locating sections, the locating sections having a configuration identical to that of the located sections, the located sections being respectively connected with the locating sections.

9. The semiautomatic rotational/swinging device as claimed in claim 2, wherein the end sections of the torsion elastic member are formed with located sections, the located sections having a polygonal cross section, the pivoting member and the relative pivoting member being formed with locating sections, the locating sections having a configuration identical to that of the located sections, the located sections being respectively connected with the locating sections.

10. The semiautomatic rotational/swinging device as claimed in claim 3, wherein the end sections of the torsion elastic member are formed with located sections, the located sections having a polygonal cross section, the pivoting member and the relative pivoting member being formed with locating sections, the locating sections having a configuration identical to that of the located sections, the located sections being respectively connected with the locating sections.

11. The semiautomatic rotational/swinging device as claimed in claim 4, wherein the end sections of the torsion elastic member are formed with located sections, the located sections having a polygonal cross section, the pivoting member and the relative pivoting member being formed with locating sections, the locating sections having a configuration identical to that of the located sections, the located sections being respectively connected with the locating sections.

12. The semiautomatic rotational/swinging device as claimed in claim 5, wherein the end sections of the torsion elastic member are formed with located sections, the located sections having a polygonal cross section, the pivoting member and the relative pivoting member being formed with locating sections, the locating sections having a configuration identical to that of the located sections, the located sections being respectively connected with the locating sections.

13. The semiautomatic rotational/swinging device as claimed in claim 6, wherein the end sections of the torsion elastic member are formed with located sections, the located sections having a polygonal cross section, the pivoting member and the relative pivoting member being formed with locating sections, the locating sections having a configuration identical to that of the located sections, the located sections being respectively connected with the locating sections.

14. The semiautomatic rotational/swinging device as claimed in claim 7, wherein the end sections of the torsion elastic member are formed with located sections, the located sections having a polygonal cross section, the pivoting member and the relative pivoting member being formed with locating sections, the locating sections having a configuration identical to that of the located sections, the located sections being respectively connected with the locating sections.

15. The semiautomatic rotational/swinging device as claimed in claim 8, wherein the locating sections are holes in which the located sections are inserted.

16. The semiautomatic rotational/swinging device as claimed in claim 9, wherein the locating sections are holes in which the located sections are inserted.

17. The semiautomatic rotational/swinging device as claimed in claim 10, wherein the locating sections are holes in which the located sections are inserted.

18. The semiautomatic rotational/swinging device as claimed in claim 11, wherein the locating sections are holes in which the located sections are inserted.

19. The semiautomatic rotational/swinging device as claimed in claim 12, wherein the locating sections are holes in which the located sections are inserted.

20. The semiautomatic rotational/swinging device as claimed in claim 13, wherein the locating sections are holes in which the located sections are inserted.

21. The semiautomatic rotational/swinging device as claimed in claim 14, wherein the locating sections are holes in which the located sections are inserted.
